(19) United States
(12) Patent Application Publication
(10) Pub. No.: US 2009/0321234 A1
(43) Pub. Date: Dec. 31, 2009

(54) INPUT KEY

(75) Inventors: BAI-DA YU, Shenzhen City (CN); GUANG-LIANG CHEN, Shenzhen City (CN); KE ZHANG, Shenzhen City (CN); PO-HSUN SHEN, Tu-Cheng (TW); XIAO-SHE BIAN, Shenzhen City (CN); WU-KUANG CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/202,330

(22) Filed: Sep. 1, 2008

(30) Foreign Application Priority Data
Jun. 27, 2008 (CN) 200810302400.2

(51) Int. Cl. H01H 9/18

(52) U.S. Cl. 200/314

(57) ABSTRACT

An exemplary key includes a main body and a filling portion. The main body is made of ceramic material. The main body defines a through hole therein. The filling portion fills the through hole. The filling portion is capable of allowing light passing through the filling portion.

### BACKGROUND OF THE INVENTION

1. Field of the Invention

The present invention relates to input keys, and particularly, to an input key used in a portable electronic device.

2. Description of the Related Art

Generally, a majority of portable electronic devices, such as personal digital assistants (PDAs), mobile phones, MP3 players and MP4 players, have keypads configured for users to input information. A keypad includes a pad and a plurality of input keys positioned on the pad.

Typically, an input key (hereinafter key) is made of transparent plastic, because of the following reasons: firstly, plastic has low melting point and high fluidity, thus keys having all kind of configurations can be easily formed by plastic; secondly, a color layer can be easily coated on keys made of plastic to form predetermined patterns; thirdly, light emitting from a light source positioned on a bottom of the key is capable of passing through the key to facilitate its use at night or during other conditions when ambient light is poor.

However, problems such as distortion, scratching, and abrasion often occur due to poor surface hardness of the key. If the key is distorted, scratched or abraded, the appearance of the key may not be as pleasant as the original appearance.

What is needed, therefore, is a new type of key that can overcome the above-mentioned shortcomings such as distortion, scratching, and abrasion of the key.

### SUMMARY

A key includes a main body and a filling portion. The main body is made of ceramic material. The main body defines a through hole therein. The filling portion fills the through hole. The filling portion is capable of allowing light passing through the filling portion.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present key. Moreover, in the drawings, like reference numerals designate corresponding parts throughout several views, and all the views are schematic.

FIG. 1 is an isometric view of the key according to a first embodiment of the present invention.

FIG. 2 is a side, cross-sectional view of the key in FIG. 1, taken along the line II-II.

FIG. 3 is a side, cross-sectional view of the key according to a second embodiment of the present invention.

FIG. 4 is a side, cross-sectional view of the key according to a third embodiment of the present invention.

FIG. 5 is a side, cross-sectional view of the key according to a fourth embodiment of the present invention.

FIG. 6 is a side, cross-sectional view of the key according to a fifth embodiment of the present invention.

### DETAILED DESCRIPTION OF THE EMBODIMENTS

Reference will now be made to the drawings to describe the embodiments of the key in detail.

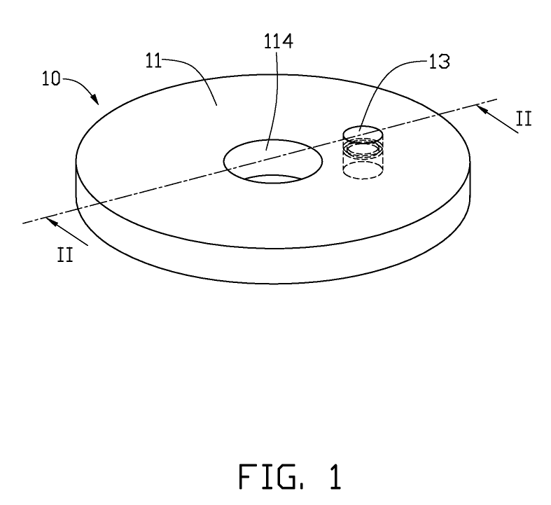

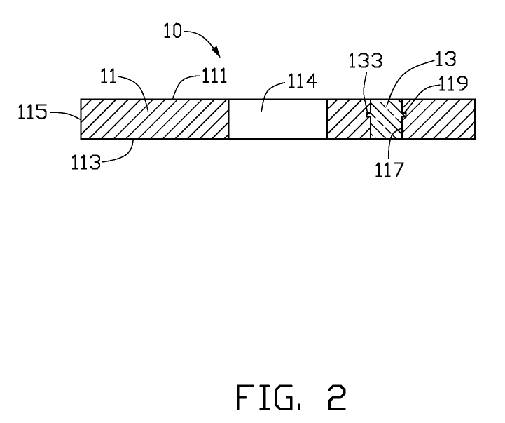

Referring to FIGS. 1 and 2, an input key 10 in accordance with a first embodiment of the present invention is shown. The key 10 includes a main body 11 and a filling portion 13. The main body 11 is integrally formed with the filling portion 13. The main body 11 is made of ceramic material, such as zirconia (ZrO₂) or alumina (Al₂O₃). The filling portion 13 is made transparent materials such as glass and plastic. In the illustrated embodiment, the filling portion 13 is made of transparent plastic. Preferably, a melting point temperature of the plastic is lower than that of the glass, therefore, the plastic filling portion 13 can be easily molded.

In the illustrated embodiment, the main body 11 includes a top surface 111, a bottom surface 113, and a side surface 115. The top surface 111 is configured for being pressed. The top surface 111 and the bottom surface 113 are on opposite sides of the main body 11. The side surface 115 connects the top surface 111 to the bottom surface 112. Both the top surface 111 and the bottom surface 113 are circular planes. The side surface 115 is a cylindrical surface. The main body 11 defines a through hole 117 communicating between the top surface 111 and the bottom surface 113. An inner wall forming the through hole 117 defines an annular depression 119. The filling portion 13 is formed in the through hole 117 by injection molding, and as a result, the filling portion 13 would further form a flange 133 corresponding to the depression 119. The flange 133 locates in the depression 119, thereby enhancing bonding strength between the filling portion 13 and the main body 11.

In addition, the main body 11 also defines an assembly hole 114 such that the key 10 can be easily mounted on a keypad (not labeled). It can be understood that, the assembly hole 114 can be omitted.

A method of making the key 10 includes the following steps: firstly, a preforming having the through hole 117 is formed by dry pressing ceramic materials. Then, the preform undergoes an abrading process and then a polishing process to form the main body 11. Afterwards, the main body 11 is integrally formed with the filling portion 13 by injection molding. Thus, the key 10 is achieved.

Since the filling portion 13 is made of transparent material and the through hole 117 is filled with the filling portion 13, light is capable of passing through the filling portion 13 in the through hole 117 to illuminate the key 20.

The key 10 has a deformation resistance ability such as high anti-distortion property, high anti-scratch property, and anti-abrasion property because ceramic materials have high hardness. Also, the filling portion 13 is received in the through hole 117 of the main body 11, an exposed, outer surface of the filling portion 13 is relatively small, generally not exceeding 0.2% to 50% of the top surface 111. In other words, the filling portion 13 is embedded in the main body 11, therefore, the filling portion 13 is seldom deformed, scratched, and abraded due to a protection of the main body 11. Therefore, the key 10 has high anti-distortion ability, high anti-scratch ability, and anti-abrasion ability.

In addition, because a potion of the filling portion 13 is exposed out of the main body 11, the filling portion 13 can be configured to be the following predetermined patterns: letters, numbers, symbols, and so on. Therefore, the patterns formed by the filling portion 13 does not decolorize easily, thus the key 10 has a high color preservation. It can be understood that, an ink layer can also be printed on the portion of the filling portion 13 exposed out of the main body 11, thereby forming predetermined patterns.

Furthermore, a desired color of the main body 11 can be achieved by varying ingredients of the ceramic material. In other words, some ingredients of the ceramic material of the main body 11 may have the desired color property, thus the key 10 has a high color preservation.

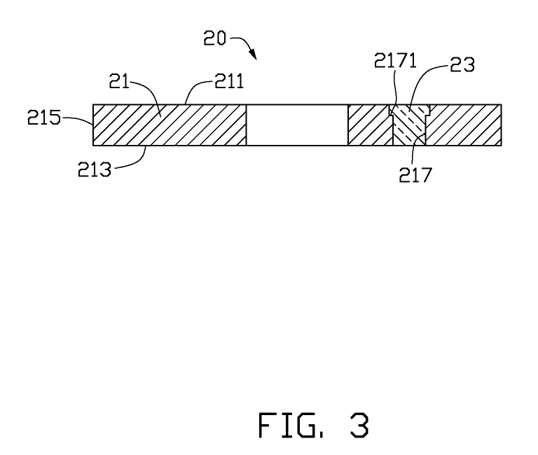

Referring to FIG. 3, a key 20 in accordance with a second embodiment of the present invention is shown. The key 20 include a main body 21 and a filling portion 23. The main body 21 includes a top surface 211, a bottom surface 213, a side surface 215, and a through hole 217. The filling portion 23 is formed in the through hole 217 by injection molding, an inner wall forming the through hole 217 forms a step portion 2171. Correspondingly, the filling portion 23 also forms a corresponding step portion (not labeled). The step portion 2171 engages with the step portion of the filling portion 23, thereby enhancing a bonding strength between the main body 21 and the filling portion 23. In addition, when the key 20 is pressed, an external force is applied to the filling portion 23, the step portion 2171 forms a force to the filling portion 23 and acts as a restricting member that prevents the filling portion 23 from detaching out of the main body 21.

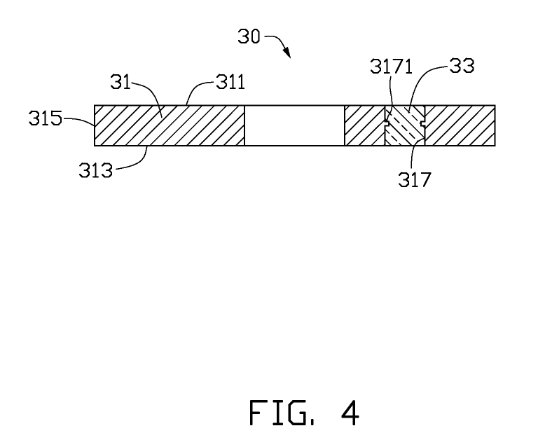

Referring to FIG. 4, a key 30 in accordance with a third embodiment of the present invention is shown. The key 30 includes a main body 31 and a filling portion 33. The main body 31 includes a top surface 311, a bottom surface 313, a side surface 315, and a through hole 317. The filling portion 33 is formed in the through hole 317 by injection molding, an inner wall forming the through hole 317 forms a flange 3171. The filling portion 33 defines a depression (not labeled). The flange 3171 is received in the depression, thereby enhancing bonding strength between the main body 31 and the filling portion 33. In addition, a height of the flange 3171 are configured to be small, thus, light passing through the through hole 317 will not be reflected by the flange 3171, and, thus, a shadow of the flange 3171 cannot be seen when viewing the key 30 externally.

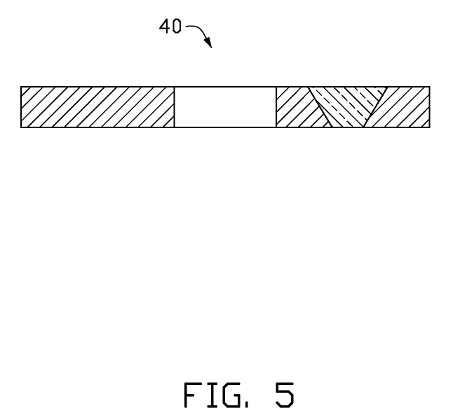

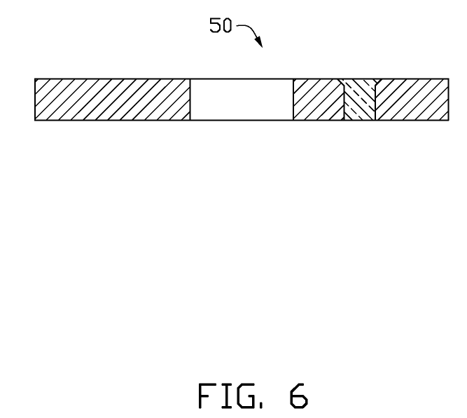

In the keys described above, a boundary of the through hole 117, 217, 317 and the filling portion 13, 23, 33 cooperatively form a latch structure such as a combination of the depression and the flange, the step portions, to increase bonding strength between the main bodies 11, 21, 31 and the filling portions 13, 23, 33. It can be understood that, a shape of the through hole can also be other shapes, such as shapes of the key 40 and the key 50 shown in FIGS. 5 and 6 respectively, the through hole can also have a pyramidal configuration. In addition, the through hole can also communicate between the side surface and the top surface. Furthermore, an inner wall forming the through hole can also be rough surface with center line average roughness (Ra) less than 200μ, thereby enhancing bonding strength between the main body and the filling portion.

It can be understood that, the main body can also be formed with other methods such as injection molding. The filling portion can also be formed with other methods such as plastic impregnation.

It can be understood that, in the above mentioned keys 10, 20 and 30, the top surface 113, 211, 311 are planar to achieve a good sense of touch. The top surface of main body can also be other shapes, such as a concave surface or a convex surface. In addition, to improve an appearance of the keys, a top view of the main body can be any other shapes, such as circular, ellipse, and polygon.

It can be understood that, the key can be used for other portable electronic devices such as keypads of computers.

Finally, while the preferred embodiment has been described and illustrated, the invention is not to be construed as being limited thereto. Various modifications can be made to the embodiments by those skilled in the art without departing from the true spirit and scope of the invention as defined by the appended claims.

What is claimed is:

1. A key comprising:
a main body made of ceramic material, the main body defining a through hole therein; and
a filling portion filling the through hole, and capable of allowing light passing through the filling portion.

2. The key of claim 1, wherein the main body includes a top surface and a bottom surface opposite to the top surface, the through hole communicates between the top surface and the bottom surface.

3. The key of claim 1, wherein a boundary of the through hole and the filling portion cooperatively form a latch structure.

4. The key of claim 3, wherein the latch structure comprises a flange formed on an inner wall in the through hole and the filling portion defines a depression therein, the flange is received in the depression.

5. The key of claim 3, wherein the latch structure comprises a depression defined in an inner wall forming the through hole and a flange formed on the filling portion.

6. The key of claim 3, wherein the latch structure comprises a step portion formed on an inner wall forming the through hole and a step portion formed on the filling portion.

7. The key of claim 1, wherein an inner wall forming the through hole is rough.

8. The key of claim 1, wherein the ceramic material includes zirconia.

9. The key of claim 1, wherein the ceramic material includes alumina.

10. The key of claim 1, wherein the filling portion is made of transparent plastic.

11. The key of claim 7, wherein an inner wall has center line average roughness (Ra) less than 200μ.

12. The key of claim 1, wherein the main body further defines an assembly hole for mounting the key to a keypad.

13. The key of claim 2, wherein the area of the through hole forms about 0.2 % to 50 % of the area of the top surface.
